(19) United States
(12) Patent Application Publication
(10) Pub. No.: US 2003/0154763 A1
(43) Pub. Date: Aug. 21, 2003

(54) Testing fluid systems

(76) Inventor: Bernard Cain, Stafford (GB)

Correspondence Address: HARRISON & EGBERT, 412 MAIN STREET, 7TH FLOOR, HOUSTON, TX, 77002, US

(21) Appl. No.: 10/333,642

(22) PCT Filed: Jul. 20, 2001
(86) PCT No.: PCT/GB01/03287

(30) Foreign Application Priority Data
Jul. 22, 2000 (GB) 0017935.8

(51) Int. Cl. G01F 25/00

(52) U.S. Cl. 73/1.16

(57) ABSTRACT

A fluid system such as a fire sprinkler system or a device such as a pressure reducing valve is tested by fitting to the system or device at least one outlet device whose characteristics are known, causing fluid to flow under test conditions, and measuring the fluid flow through the outlet device to give an indication of which flow would take place under normal operating conditions. The outlet device may be a flow restrictor.

### DESCRIPTION OF INVENTION

This invention relates to the testing of fluid systems. More particularly it relates to the establishment of test conditions under which testing can be carried out, in order to find out what one or more operating characteristics of a system will be under actual operating conditions.

The invention has been devised in relation to the testing of wet fire systems. Such systems, which include fire sprinkler systems and wet riser systems for supplying water to sprinklers or hose reels at different locations, commonly are installed in commercial premises with the object of extinguishing a fire if one starts. Before a fire has a chance to spread and cause great and widespread damage, devices such as temperature sensors are utilised to bring the system into operation.

Wet fire systems, e.g. sprinkler systems or systems providing for the connection of hoses, might be installed in many or all storeys of a multi-storey building and each storey might have a large floor area. If the entire system is in operation, very large quantities of water are used and it is important that sufficient water for fire control purposes is delivered from all parts of the system. However, to test the entire system by causing full-scale operation thereof is unrealistic because of the quantity of water which has to be used overall and collected/measured at particular points. It is therefore desirable that testing should be able to be carried out at less than such full-scale operation of the system.

It is broadly the object of the present invention to provide for such testing.

According to one aspect of the invention, therefore, we provide a method of establishing an operating characteristic of a fluid system or device having an inlet and at least one outlet, comprising providing the device, system, or a model of the system, with at least one outlet device having predetermined characteristics; causing flow of fluid through the device, system or model under test conditions; measuring the flow of fluid at said at least one outlet; and deriving from said measured flow an indication of said operating characteristic.

The fluid which is caused to flow in said test conditions may be a gas, e.g. air, or may be a liquid conveniently water.

In applying the invention to a wet fire system, e.g. a fire sprinkler system, the characteristic which is established may be a flow rate which would occur under actual operating conditions at one or more positions, e.g. an individual sprinkler outlet or outlets, in the system.

In such application of the invention, one or more outlets of the system may be fitted with devices able to measure flow rates (volume in a predetermined time) of fluid flowing at the outlet. If a known flow of fluid is introduced into the system at its inlet, the measured flow of fluids at the outlets under the test conditions gives an indication of what flows would take place under normal operating conditions.

For example a system may be tested by providing a known flow of air into the inlet of the system, and the flows of air at a predetermined number of outlets of the system can be measured. The measurements thus obtained enable, by calculation and extrapolation, information to be derived as to what would take place if the system were operating normally with water as the fluid. Drawings including information as to pipe sizes, pipe lengths and elevations could be analysed and calculations made to determine the relationship been water flows under normal operating conditions and air flows under test conditions. The relationship should be such that it will be possible for a wet fire system to be certificated as being in compliance with operating standards, on the basis of a test using air or other gas as the operating fluid.

One device which the invention may be utilised in testing is a pressure reducing valve, intended to provided a predetermined outlet pressure whatever inlet pressure it is subject to. A wet fire system in a multi-storey building may have such a reducing valve at each storey, so that further parts of the system, e.g. sprinklers or hose reels, on each storey are operated under the same water supply pressure. Without such reducing valves, the pressure available at the lower storeys would be greater than that at the higher storeys.

For testing such pressure reducing valves, the invention provides that an outlet flow-restricting means may be connected at the outlet of the valve and fluid caused to flow therethrough. The flow of fluid through the flow-restricting means indicates the outlet pressure which is maintained by the pressure reducing valve.

For testing a pressure reducing valve, apparatus may be connected to its outlet comprising stop valve means, the flow restricting means, and flow measuring means. The flow measuring means may comprise a means for measuring the quantity of fluid which passes through the flow restricting means in a predetermined time, e.g. by measuring the weight or possibly the volume of water which passes in such time.

The apparatus may include timing means which causes the stop valve means to be opened for a predetermined length of time, whereupon the amount of fluid passing the flow restricting means in such length of time can be measured. Preferably electronic timing means is utilised, having an output which can be applied to an electrically operable stop valve means to cause the latter to open for the predetermined time.

The invention will now be described by way of example with reference to the accompanying drawings, of which:

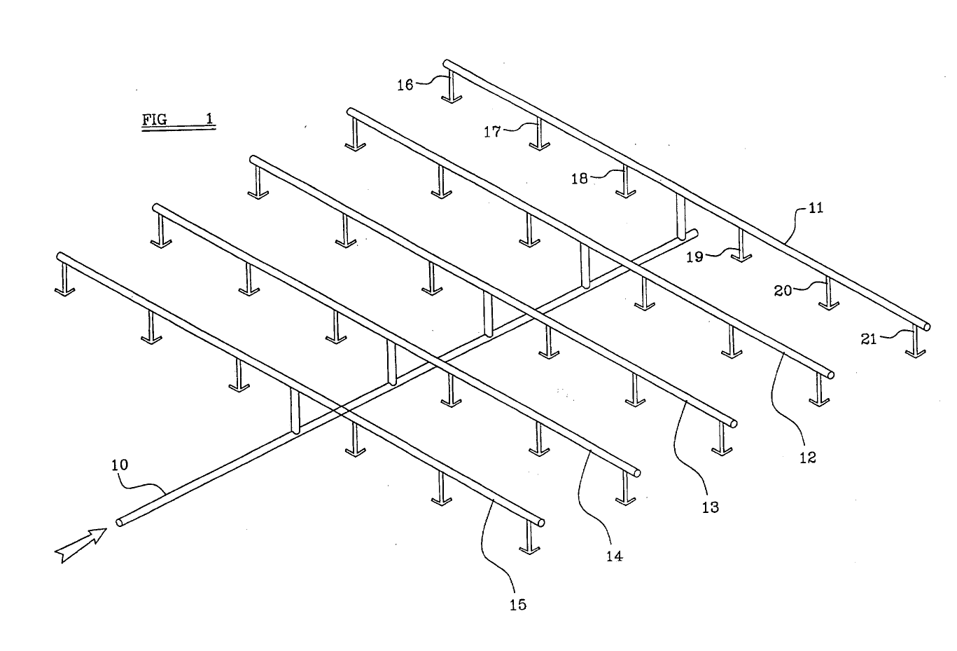

FIG. 1 illustrates diagrammatically part of a fire sprinkler system;

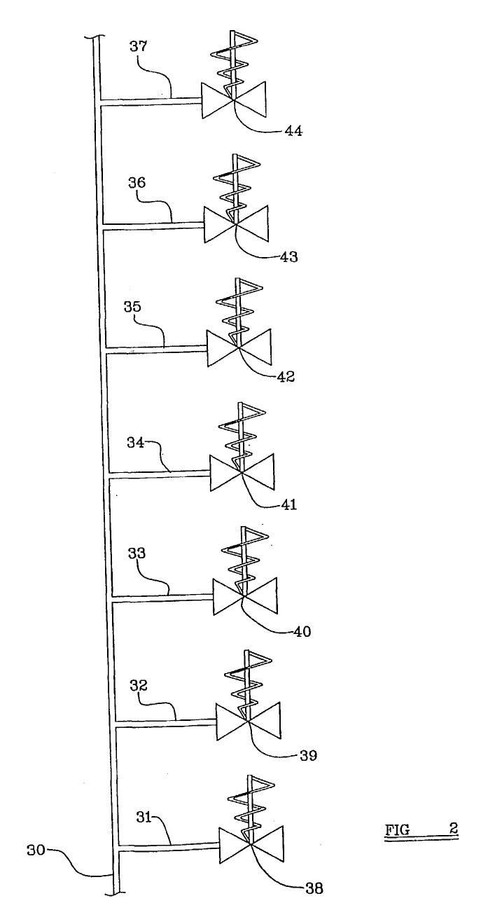

FIG. 2 illustrates diagrammatically the layout of part of a fire sprinkler system.

Referring firstly to FIG. 1 of the drawings, this shows diagrammatically a typical layout of a fire sprinkler system. It comprises an inlet pipe 10 leading to five main outlet pipes 11 to 15, each of which has six sprinkler outlets as indicated at 16 to 21 on the outlet pipe 11. It will be appreciated that a sprinkler system may in fact have much more pipework and sprinkler outlets than those illustrated depending on the nature and size of the premises in which the system is installed.

When such a system is in operation it is important that each of the sprinkler outlets provides an adequate flow rate of water. In order to establish whether this requirement is met, each of the sprinkler outlets is removed and in its place is fitted a respective measuring device that is able to measure low levels of air or water flow. A known flow of such fluid is introduced to the system at its inlet and such flow should be divided between the outlets substantially equally, i.e. each outlet should give substantially the same flow. Differences between the outlets can be scaled by known factors and verified by laboratory test conditions, to obtain an indication of what will happen under operational conditions, i.e. with full scale liquid flows.

FIG. 2 shows diagrammatically part of a fire sprinkler system at which several storeys of a multi-storey building are supplied. An outlet riser pipe is indicated at 30 and respective branches 31 to 37 provide the inlets to respective parts of the sprinkler system on respective storeys of the building. It will be appreciated that the water pressure available at these inlets decreases as one ascends the building, as indicated on the Figure. Therefore the sprinkler systems on each storey are fed through respective reducing valves 38 to 44 which give a predetermined pressure outlet, e.g. six bar. This pressure should be maintained in use, irrespective of the flow rate through the valve.

To verify the effectiveness of each pressure reducing valve, the outlet side thereof is fitted with apparatus so that the actual pressure setting of the pressure reducing valve can be measured and determined. Such apparatus will indicate whether the pressure reducing valve is set and maintaining the required outlet pressure.

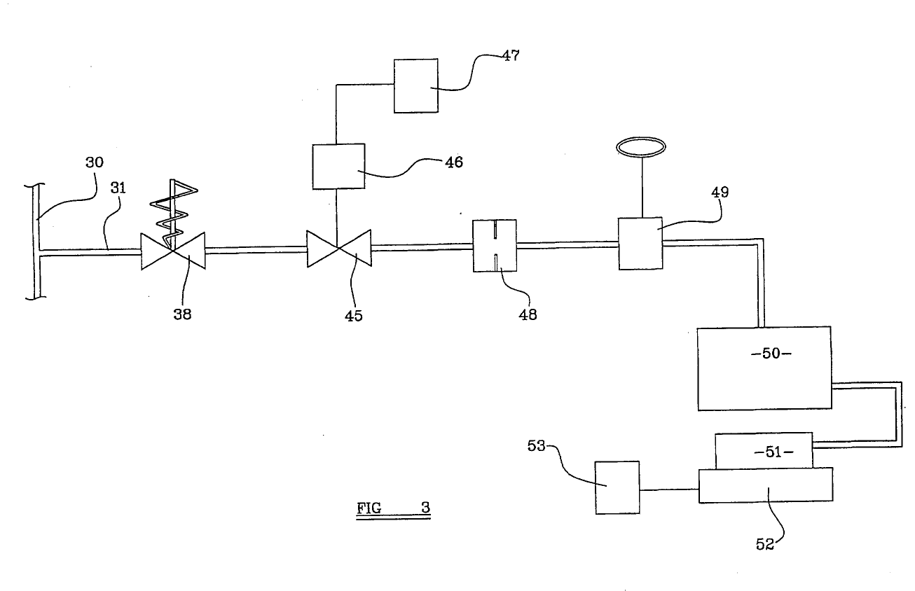

FIG. 3 shows diagrammatically an arrangement of such apparatus. It is connected at the outlet of one of the pressure reducing valves 38-44, here indicated as 38. The apparatus comprises an electrically operable stop valve means 45 whose electrically-powered operating device 46 is controlled by the output from a timer 47, so that the stop valve 45 can be opened for a predetermined period of time and then shut. The valve 45 must be capable of opening against a large pressure on its inlet side and zero pressure on its outlet side: such conditions might exist if the pressure reducing valve is incorrectly set or is not functioning properly.

To the outlet from the stop valve 45 is connected a flow restricting means 48 which preferably is an orifice of suitable size. By way of a manually operable stop valve 49, the outlet from the flow restricting means 48 passes to an intermediate tank 50 and thence to a measuring tank 51 on a weighing apparatus 52. The intermediate tank provides for the amount of water passing through the flow restricting means 48 in the time the valve 45 is open to be delivered to the measuring tank 51 and weighed so that the quantity of water which has passed can be determined. Although not shown in the drawing, there will be of course be provision for release to drainage of the water which has been used in each test level.

The apparatus may incorporate a digital analyser 53 and a printer to provide written details of the pressure and flow setting that is registered and if necessary the modification that will be necessary to alter the performance of the pressure reducing valve to provide the correct pressure and flow required for the design of the system.

Information from a number of such tests can be used to plot a performance curve for a reducing valve, that can be validated.

In the present specification “comprise” means “includes or consists of” and “comprising” means “including or consisting of”.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A method of establishing an operating characteristic of a fluid system or device having an inlet and at least one outlet, comprising providing the device, system or a model of the system with at least one outlet device having predetermined characteristics, causing flow of fluid through the device system or model under test conditions; measuring the flow of fluid at said at least one outlet; and deriving from said measured flow an indication of said operating characteristic.

2. A method according to claim 1 wherein the system is a wet fire system.

3. A method according to claim 2 comprising fitting one or more outlets of the system with devices for measuring flow rates of fluid, introducing a known flow of fluid into the system at its inlet, and measuring the flow of fluid at said one or more outlets.

4. A method according to any one of the preceding claims wherein said fluid caused to flow in said test conditions is a gas.

5. A method according to any one of claims 1 to 3 wherein said fluid which is caused to flow in said test conditions is water.

6. A method according to claim 1 wherein said device is a pressure reducing valve.

7. A method according to claim 6 wherein an outlet flow restricting means is connected at the outlet of the valve.

8. A method according to claim 7 comprising measuring the quantity of fluid which passes through the flow restricting means in a predetermined time.

9. A method according to claim 8 wherein said quantity of fluid is measured by weighing it.

10. Apparatus for testing a pressure reducing valve, comprising a flow restricting means for connection to the outlet of the valve, and flow measuring means for measuring the flow of fluid through the valve and flow restricting means.

11. Apparatus according to claim 10 further comprising stop valve means.

12. Apparatus according to claim 11 further comprising timing means operable for causing the stop valve means to be opened for a predetermined period of time.

13. Apparatus according to claim 12 further comprising weighing means for determining the quantity of fluid which has passed through the valve in said predetermined period of time.

14. A method or apparatus substantially as hereinbefore described with reference to and as shown in the accompanying drawings.

15. Any novel feature or novel combination of features described herein and/or in the accompanying drawings.
